(19) United States
(12) Patent Application Publication
(10) Pub. No.: US 2020/0200135 A1
(43) Pub. Date: Jun. 25, 2020

(54) COMPRESSION IGNITION ENGINE

(71) Applicant: MAZDA MOTOR CORPORATION, Hiroshima (JP)

(72) Inventors: Sangkyu KIM, Higashihiroshima-shi (JP); Takashi SUMIMOTO, Hiroshima-shi (JP); Shintaro OKADA, Higashihiroshima-shi (JP); Daisuke SHIMO, Hiroshima-shi (JP); Tomoyuki KANDA, Hiroshima-shi (JP); Shinichiro TAGAMI, Hiroshima-shi (JP); Kazunori HIRABAYASHI, Hiroshima-shi (JP)

(73) Assignee: MAZDA MOTOR CORPORATION, Hiroshima (JP)

(21) Appl. No.: 16/593,628

(22) Filed: Oct. 4, 2019

(30) Foreign Application Priority Data
Dec. 25, 2018 (JP) 2018-240612

(51) Int. Cl. F02M 61/18; F02B 3/06; F02F 3/26; F02M 61/14

(52) U.S. Cl. CPC F02M 61/1813; F02M 61/14; F02F 3/26; F02B 3/06

(57) ABSTRACT

A cavity provided at a crown surface of a piston includes a first cavity section provided in a central area in a radial direction, a second cavity section provided outside the first cavity section, and a lip provided to connect the first-and-second cavity sections. Plural injection holes of an injector include a first injection-hole group where plural first injection holes directed toward a part close to the piston in a cylinder-axis direction are provided in a ring shape and a second injection-hole group where plural second injection holes directed toward a part close to a ceiling surface of a combustion chamber in the cylinder-axis direction are provided in the ring shape. The first injection-hole group and the second injection-hole group are positioned so as to inject fuel toward the lip concurrently.

### BACKGROUND OF THE INVENTION

The present invention relates to a direct-injection type compression ignition engine in which a part of a combustion chamber is formed by a piston provided with a cavity.

The combustion chamber of an engine for a vehicle, such as an automotive vehicle, is formed by an inner wall surface of a cylinder, a bottom surface of a cylinder head (a ceiling surface of the combustion chamber) and a crown surface of the piston. In the direct-injection type compression ignition engine, fuel is supplied into the combustion chamber from a fuel injector provided at a central portion, in a radial direction, of the ceiling surface of the combustion chamber. An engine in which the cavity is provided at the crown surface of the piston and the fuel is injected from the fuel injector toward the cavity is known. Further, an engine in which the cavity has a two-stage structure in which an upper cavity and a lower cavity are provided and fuel is injected toward a lip which is located at a middle position between the both cavities is known (Japanese Patent Laid-Open Publication No. 2007-211644 (its counterpart US Patent Application Publication No. 2009/0025675 A1)). Moreover, a fuel injection device in which plural injection holes to actually inject fuel are arranged in upper-and-lower two rows in a cylinder-axis direction and these injection holes are opened/closed having time difference is known (Japanese Patent No. 5962795 (its counterpart US Patent Application Publication No. 2016/0237972 A1)).

An ideal manner of combustion in the combustion chamber is to perform the combustion so that air existing in the combustion chamber is used up. In an engine where a part of the combustion chamber is formed by the crown surface of the piston provided with the above-described upper/lower two-stage structural cavity, it is important that the fuel is injected toward the lip such that a fuel spray is separately flowed into the upper cavity and the lower cavity.

Meanwhile, a fuel injection timing of the fuel injector may need to be advanced or delayed according to a driving condition and the like in order to secure the appropriate combustion. Herein, there may be a case where the fuel spray to be separately flowed into the upper-and-lower cavities is so affected by changing of the advanced or delayed fuel injection timing that flowing of the fuel spray deflects to one of the cavities. In this case, there is a concern that oxygen existing in this one of the cavities may not be utilized sufficiently, whereas the fuel existing in the other cavity may not be burned perfectly.

### SUMMARY OF THE INVENTION

An object of the present invention is to provide a compression ignition engine in which a part of the combustion chamber is formed by the crown surface of the piston provided with the upper/lower two-stage structural cavity, which can make the fuel spray be separately flowed into the both cavities properly regardless of changing (advancing/delaying) of the fuel injection timing.

The present invention is a compression ignition engine, comprising a combustion chamber formed by a cylinder, a ceiling surface of a cylinder head, and a crown surface of a piston, a fuel injector provided at a central portion, in a radial direction, of the ceiling surface along a cylinder axis and including plural injection holes to inject fuel into the combustion chamber, and a cavity provided at the crown surface of the piston, wherein the cavity includes a first cavity section which is provided in a central area, in the radial direction, of the crown surface and has a first bottom portion having a first depth, in a direction of the cylinder axis, from the crown surface, a second cavity section which is provided outside the first cavity section and has a second bottom portion having a second depth, in the direction of the cylinder axis, from the crown surface, the second depth being shallower than the first depth, and a lip which is provided to connect the first cavity section and the second cavity section, the plural injection holes of the fuel injector include a first injection-hole group where plural first injection holes which are directed toward a part close to the piston in the cylinder-axis direction are provided in a ring shape and a second injection-hole group where plural second injection holes which are directed toward a part close to the ceiling surface in the cylinder-axis direction are provided in the ring shape, and the first injection-hole group and the second injection-hole group are positioned so as to inject the fuel toward the lip concurrently.

According to the present invention, the first injection-hole group having the injection holes directed toward the part close to the piston and the second injection-hole group having the injection holes directed toward the part close to the ceiling surface are provided as the plural injection holes of the fuel injector. The injection holes of these first-and-second injection-hole groups inject the fuel toward the lip concurrently. Thereby, an injection-hole angle (an angle which an injection-hole axis makes with the cylinder axis) of the fuel injector can be enlarged. Accordingly, even in a case where the fuel injection timing is advanced or delayed to a certain degree, the fuel splay is made to hit against the lip so that the fuel spay can be separately flowed into the first and second cavity sections properly. Accordingly, the flowing of the fuel spray is prevented from deflecting to either one of the cavity sections, so that the oxygen existing in the combustion chamber can be utilized effectively and also appropriate burning of the fuel can be attained, suppressing generation of any improper soot. Herein, while the injection-hole angle may be enlarged by increasing an outlet size of each injection hole, this is not preferable because it is required to make the fuel injector excessively large for securing sufficient penetration.

In an embodiment of the present invention, respective outlets of the plural first injection holes are provided in the ring shape at the same level in the cylinder-axis direction, and respective outlets of the plural second injection holes are provided in the ring shape at the same level in the cylinder-axis direction, the level at which the respective outlets of the plural second injection holes are provided being offset, in the cylinder-axis direction, from the level at which the respective outlets of the plural first injection holes are provided.

According to this embodiment, the respective injection-hole outlets of the first-and-second injection holes can be arranged so as to secure a proper distance, in a peripheral direction, between the adjacent outlets by the above-described offset arrangement. Accordingly, a size of an arrangement part of the injection holes at the fuel injector can be made properly small compared to a case where the injection holes are arranged in a line (non-offset), thereby suppressing the fuel injector from being improperly large. Herein, if the injection holes are arranged in a line in a state where the outlet size of the injection holes is maintained, the distance between the adjacent injection-hole outlets in the peripheral direction become so small that the respective fuel sprays injected from the adjacent outlets interfere with each other, so that there may occur a problem that a partially-rich air-fuel mixture is improperly generated.

In another embodiment of the present invention, the respective outlets of the plural first injection holes are provided in the ring shape at regular intervals, the respective outlets of the plural second injection holes are provided in the ring shape at regular intervals, and the outlets of the plural injection holes of the first-and-second injection-hole groups are arranged such that each outlet of the plural injection holes of one of the first-and-second injection-hole groups is located at a middle position between adjacent outlets of the plural injection holes of the other group.

According to this embodiment, it can be suppressed that the respective fuel sprays injected from the adjacent injection-hole outlets interfere each other in each of the first-and-second injection-hole groups. Further, interference of the fuel sprays injected from the outlet of the injection hole of the first injection-hole group and the outlet of the injection hole of the second injection-hole group can be suppressed as well.

In another embodiment of the present invention, the fuel injector comprises a sack portion where the fuel is filled and a sack wall which partitions the sack portion which are provided at a tip portion thereof exposed to the combustion chamber, and the first injection holes of the first injection group and the second injection holes of the second injection group are respectively formed at the sack wall and have the same injection-hole diameter.

According to this embodiment, the fuel filled in the sack portion is injected from the injection holes of the first-and-second injection-hole groups. Herein, since the injection-hole diameter of the injection holes of the first injection-hole group is equal to the injection-hole diameter of the injection holes of the second injection-hole group, it can be prevented that each fuel injection from the respective groups is improperly biased.

Other features, aspects, and advantages of the present invention will become apparent from the following description which refers to the accompanying drawings.

### BRIEF DESCRIPTION OF THE DRAWINGS

FIG. 1 is a schematic sectional diagram, in a cylinder-axis direction, of a diesel engine according to an embodiment of a compression ignition engine of the present invention.

FIG. 2A is a perspective view of a crown portion of a piston of the diesel engine shown in FIG. 1, and FIG. 2B is a perspective sectional view of the piston.

FIG. 3 is an enlarged view of a cross section of the piston shown in FIG. 2B.

FIG. 4 is a diagram for explaining respective curved-surface shapes of first-and-second cavity sections and a lip.

FIG. 5A is a schematic sectional view of a tip portion of an injector (fuel injector) according to the embodiment, and FIG. 5B is a plan view of the tip portion, when viewed in the cylinder-axis direction.

FIGS. 6A, 6B are schematic diagrams showing a state of a fuel spray from the injector, FIG. 6A being its diagram when viewed in the cylinder-axis direction, FIG. 6B being its diagram when viewed in a direction perpendicular to the cylinder-axis direction.

FIG. 7 is a sectional view of the piston which explains a relationship between a crown surface of the piston and an injection-hole axis of fuel injected from the injector.

FIG. 8 is a top view of the piston, which shows a distribution pattern of a fuel spray to the first-and-second cavity sections.

FIG. 9 is a time chart showing a fuel-injection timing and a heat generation rate.

FIG. 10 is a diagram schematically showing a generation state of an air-fuel mixture in a combustion chamber in a main injection.

FIGS. 11A, 11B are diagrams showing injection states of the fuel injected toward the lip, FIG. 11A showing a case of a comparative example in which injection-hole axes of upper-and-lower two-stage injection-hole groups are parallel, FIG. 11B showing a case of the present embodiment.

FIGS. 12A, 12B are diagrams showing distribution states of the fuel spay, FIG. 12A showing a case of the comparative example, FIG. 12B showing a case of the present embodiment.

FIGS. 13 A-13E are diagrams showing various arrangement patterns of the injection holes in a case where the first injection-hole group and the second injection-hole group are provided to be vertically offset from each other.

FIGS. 14 A-14C are diagrams showing examples of the injection-hole arrangement in a case where the first injection-hole group and the second injection-hole group are arranged in a line.

### DETAILED DESCRIPTION OF THE INVENTION

[Whole Structure of Engine]

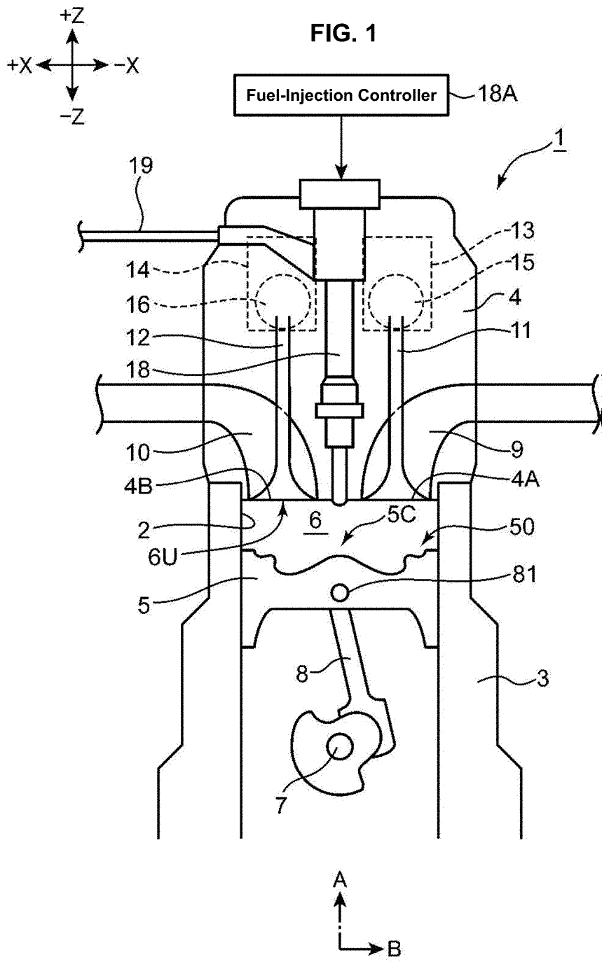

Hereafter, a compression ignition engine according to an embodiment of the present invention will be described referring to the drawings. FIG. 1 is a schematic sectional diagram showing a direct-injection type diesel engine according to the embodiment of the compression ignition engine of the present invention. The diesel engine of the present embodiment includes a cylinder and a piston, which is a multi-cylinder engine which is installed to a vehicle as a power source for driving the vehicle, such as an automotive vehicle. The engine includes an engine body 1 and auxiliary elements assembled thereto, such as intake/exhaust manifolds and various pumps, not illustrated.

The engine body 1 comprises a cylinder block 3, a cylinder head 4, and a piston 5. The cylinder block 3 comprises plural cylinders and cylinder liners (hereafter, referred to as a “cylinder 2” simply, only one of these is illustrated in the figure) which are aligned in a direction perpendicular to a page of FIG. 1. The cylinder head 4 is attached to an upper surface of the cylinder block 3 so as to cover an upper opening of the cylinder 2. The piston 5 is accommodated in the cylinder 2 so as to slide reciprocatively, which is coupled to a crankshaft 7 via a connecting rod 8. The crankshaft 7 is rotated around its central axis according to a reciprocating motion of the piston 5. The structure of the piston 5 will be described specifically later.

A combustion chamber 6 is formed at an upper part of the piston 5. At the cylinder head 4 are formed an intake port 9 and an exhaust port 10 which respectively connect to the combustion chamber 6. A bottom surface of the cylinder head 4 is a combustion-chamber ceiling surface 6U, which is configured to have a flat shape extending in a horizontal direction. An intake-side opening portion 4A which is a downstream end of the intake port 9 and an exhaust-side opening portion 4B which is an upstream end of the exhaust port 10 are formed at the combustion-chamber ceiling surface 6U. An intake valve 1A to open/close the intake-side opening portion 4A and an exhaust valve 12 to open/close the exhaust-side opening portion 4B are assembled to the cylinder head 4.

The intake valve 11 and the exhaust valve 12 are a so-called poppet type. The intake valve 11 comprises an umbellar-shaped valve body to open/close the intake-side opening portion 4A and a stem which is provided to extend vertically from the valve body. Likewise, the exhaust valve 12 comprises an umbellar-shaped valve body to open/close the exhaust-side opening portion 4B and a stem which is provided to extend vertically from the valve body. Each of the valve bodies of the intake valve 11 and the exhaust valve 12 has a valve surface which is exposed to the combustion chamber 6.

In the present embodiment, a combustion-chamber wall surface which partitions the combustion chamber 6 comprises an inner wall surface of the cylinder 2, a crown surface 50 as an upper surface (+Z-side surface) of the piston 5, the combustion-chamber ceiling surface 6U (ceiling surface) which is a bottom surface of the cylinder head 4, and the respective valve surfaces of the intake valve 11 and the exhaust valve 12.

The cylinder head 4 is provided with an intake-side valve train (valve driving mechanism) 13 and an exhaust-side valve train (valve driving mechanism) 14 which drive the intake valve 11 and the exhaust valve 12, respectively. The intake valve 11 and the exhaust valve 12 are driven by these valve trains 13, 14 so as to be liked with a rotation of the crankshaft 7. According to the driving of the intake valve 11 and the exhaust valve 12, the valve body of the intake valve 11 opens/closes the intake-side opening portion 4A and the valve body of the exhaust valve 12 opens/closes the exhaust-side opening portion 4B.

An intake-side variable valve timing mechanism (intake-side VVT) 15 is installed to the intake-side valve train 13. The intake-side VVT 15 is an electric-type VVT which is provided at an intake camshaft, which is configured to change an opening/closing timing of the intake valve 11 by continuously changing a rotational phase of the intake camshaft to the crankshaft 7 within a specified angle range. Likewise, an exhaust-side variable valve timing mechanism (exhaust-side VVT) 16 is installed to the exhaust-side valve train 14. The exhaust-side VVT 16 is also an electric-type VVT which is provided at an exhaust camshaft, which is configured to change an opening/closing timing of the exhaust valve 12 by continuously changing a rotational phase of the exhaust camshaft to the crankshaft 7 within a specified angle range.

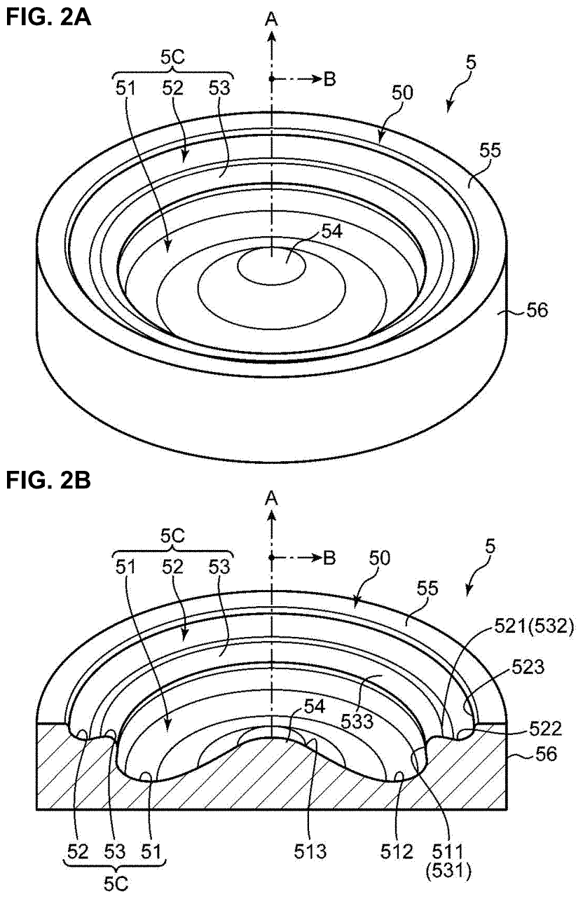

An injector 18 (fuel injector) to inject fuel into the combustion chamber 6 from its tip portion is attached to the cylinder head 4 (the combustion-chamber ceiling surface 6U) for each of the cylinders 2. A fuel supply pipe 19 is coupled to the injector 18. The injector 18 injects the fuel supplied through the fuel supply pipe 19 into the combustion chamber 6 directly. In the present embodiment, the injector 18 is assembled to the cylinder head 4 at a central portion, in a radial direction, of the combustion chamber 6 so as to extend in a cylinder-axis direction A, and injects the fuel toward a cavity 5C (FIGS. 2A, 2B-4) which is formed at a crown surface 50 of the piston 5, which is will be described specifically. A specific structure of the injector 18 will be described later.

A high-pressure fuel pump (not illustrated) which is comprised of a plunger type pump linked with the crankshaft 7 and others is coupled to an upstream side of the fuel supply pipe 19. A common rail for pressure accumulation (not illustrated) which is common to all of the cylinders 2 is provided between the high-pressure fuel pump and the fuel supply pipe 19. The pressured fuel accumulated in this common rail is supplied to the injector 18 provided at each cylinder 2, so that the high-pressure fuel is injected into the combustion chamber 6 from each injector 18.

[Specific Structure of Piston]

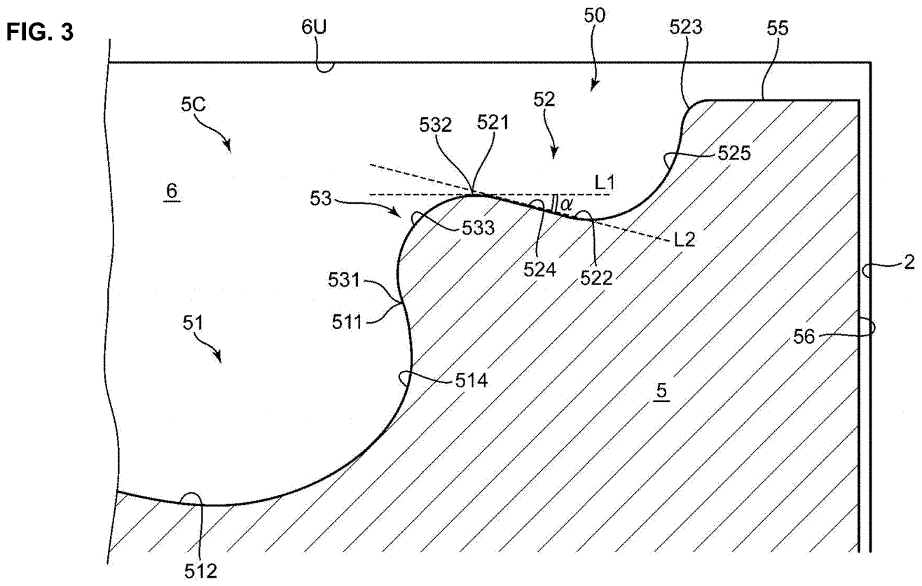

Subsequently, a structure of the piston 5, in particular the crown surface 50, will be described specifically. FIG. 2A is a perspective view showing an upper part of the piston 5 primarily. The piston 5 comprises a piston head positioned at its upper side and a skirt portion positioned at its lower side, and FIG. 2A shows a portion of the piston head which has the crown surface 50 at its top. FIG. 2B is a perspective sectional view of the piston 5 along a radial direction. FIG. 3 is an enlarged view of the radial-direction cross section shown in FIG. 2B. In FIGS. 2A and 2B, the cylinder-axis direction A and a combustion-chamber radial direction B are shown by arrows.

The piston 5 includes the cavity 5C, a squish area 55, and a side peripheral surface 56. As described above, a part (bottom surface) of the combustion-chamber wall surface which partitions the combustion chamber 6 is formed by the crown surface 50 of the piston 5, and the cavity 5C is provided at the crown surface 50. The cavity 5C is a portion which is formed by configuring the crown surface 50 to be recessed downwardly in the cylinder-axis direction A, which receives the fuel injected from the injector 18. The squish area 55 is a ring-shaped flat surface portion which is positioned at an area near an outer peripheral edge, in the radial direction B, of the crown surface 50. The cavity 5C is provided at a central area, in the radial direction B, of the crown surface 50, excluding the squish area 55. The side peripheral surface 56 is a surface which slides the inner wall surface of the cylinder 2, which is provided with plural ring grooves where piston rings, not illustrated, are inserted.

The cavity 5C includes a first cavity section 51, a second cavity section 52, a lip 53, and a mountain section 54. The first cavity section 51 is a recess portion which is provided at the central area, in the radial direction B, of the crown surface 50. The second cavity section 52 is a ring-shaped recess portion which is provided outside the first cavity section 51 at the crown surface 50. The lip 53 is a portion which connects the first cavity section 51 and the second cavity section 52 in the radial direction B. The mountain section 54 is a mountain-shaped protrusion portion which is provided at a central position, in the radial direction B, of the crown surface 50 (the first cavity section 51). The mountain section 54 is configured to protrude upwardly at a position located right below a nozzle 181 of the injector 18.

The first cavity section 51 includes a first upper-end portion 511, a first bottom portion 512, and a first inner-end portion 513. The first upper-end portion 511 is located at the highest level at the first cavity section 51 and continuous to the lip 53. The first bottom portion 512 is a ring-shaped area, in a top view, which is configured to be recessed downwardly the most in the first cavity section 51. This first bottom portion 512 is the deepest area of the cavity 5C, and the first cavity section 51 has a specified depth (first depth) in the cylinder-axis direction A at the first bottom portion 512. The first bottom portion 512 is positioned near inside the lip 53 in the radial direction B.

A radial-direction concaved portion 514 which is curved outwardly in the radial direction B is provided to connect the first upper-end portion 511 and the first bottom portion 512. This radial-direction concaved portion 514 includes a section which is concaved outwardly, in the radial direction B, from the lip 53. The first inner-end portion 513 is located at the innermost position, in the radial direction, of the first cavity section 51, and continuous to a lower end of the mountain section 54. The first inner-end portion 513 and the first bottom portion 512 are connected by a gently-curved skirt-shaped surface.

The second cavity section 52 includes a second inner-end portion 521, a second bottom portion 522, a second upper-end portion 523, a taper area 524, and a rising wall area 525. The second inner-end portion 521 is located at the innermost position, in the radial direction B, of the second cavity section 52 and continuous to the lip 53. The second bottom portion 522 is an area which is configured to be recessed downwardly the most in the second cavity section 52. The second cavity section 52 has a shallower depth (second depth), in the cylinder-axis direction A, than the first bottom portion 512 at the second bottom portion 522. That is, the second cavity section 52 is a recess portion which is located at a higher level than the first cavity section 51 in the cylinder-axis direction A. The second upper-end portion 523 is located at the highest level and the outermost position, in the radial direction B, of the second cavity section 52 and continuous to the squish area 55.

The taper area 524 is a portion which extends from the second inner-end portion 521 toward the second bottom portion 522 so as to have a surface which slants outwardly and downwardly. As shown in FIG. 3, the taper area 524 is inclined along an inclination line L2 which crosses a horizontal line L1 extending in the radial direction B by an inclination angle α. The rising wall area 525 is a wall surface which is configured to rise relatively steeply on the outward side, in the radial direction B, of the second bottom portion 522. A curved surface, in a sectional view along the radial direction B, is formed between the second bottom portion 522 and the second upper-end portion 523 such that an extensional direction of the wall surface of the second cavity section 52 changes from the horizontal direction to the upward direction. A part of this curved surface which is located near the second upper-end portion 523 and configured to be nearly vertical is the rising wall area 525.

The lip 53 is configured to protrude inwardly in the radial direction B at a position between the lower-side first cavity section 51 and the upper-side second cavity section 52 in the sectional view along the radial direction B. The lip 53 comprises a lower end portion 531, a third upper-end portion 532 (an upper end portion in the cylinder-axis direction), and a central portion 533 which is located at a central position between these portions 531, 532. The lower end portion 531 is a connected section to the first upper-end portion 511 of the first cavity section 51. The third upper-end portion 532 is a connected section to the second inner-end portion 521 of the second cavity section 52.

In the cylinder-axis direction A, the lower end portion 531 is the lowermost portion and the third upper-end portion 532 is the uppermost portion. The above-described taper area 524 is also an area extending from the third upper-end portion 532 to the second bottom portion 522. The second bottom portion 522 is located at a lower level than the third upper-end portion 532. That is, the second cavity section 52 of the present embodiment does not have any bottom surface extending horizontally outwardly, in the radial direction B, from the third upper-end portion 532, in other words, there is no horizontal surface extending from the third upper-end portion 532 to the squish area 55, but the second cavity section 52 has the second bottom portion 522 recessed downwardly from the third upper-end portion 532.

The mountain section 54 which protrudes upwardly has its height equal to the height of the third upper-end portion 532 of the lip 53, and the mountain section 54 is located at the level lower than the squish area 55. The mountain section 54 is positioned at a center of the first cavity section 51 having a circular shape in the top view, so that the first cavity section 51 is configured to be a ring-shaped groove part surrounding the mountain section 54.

[Curved-Surface Shapes of Cavity Sections]

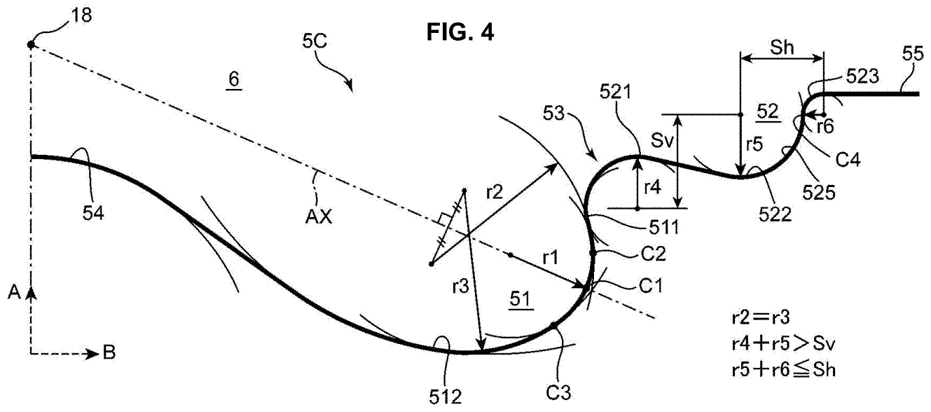

FIG. 4 is a sectional view along the cylinder-axis direction A for explaining respective curved-surface shapes of the first-and-second cavity sections 51, 52 and the lip 53. The first cavity section 51 has a surface shape corresponding to a curved shape of a Cartesian oval (hereafter, referred to as an “egg shape”) in the cross section including the cylinder axis. Specifically, the first cavity section 51 includes a first part C1 farthest from the injection holes of the injector and has an arc shape, a second part C2 which is located between the first part C1 and the lip 53, and a third part C3 which extends inwardly, in the radial direction B, from the first part C1. Referring to FIG. 3 as well, the first part C1 corresponds to a central area of the radial-direction concaved portion 514, the second part C2 corresponds to an area extending from the radial-direction concaved portion 514 to the first upper-end portion 511, and the third part C3 corresponds to the an area extending from the radial-direction concaved portion 514 to the first bottom portion 512.

FIG. 4 shows a state where an injection-hole axis AX of the fuel injected from the injector 18 crosses the first part C1 farthest from the injector 18. The “egg shape” of the first cavity section 51 is an arc shape in which a radius r1 of the first part C1 is the smallest, and a radius of a curved part extending from the first part C1 to the second part C2 and a radius of a curved part extending from the first part C1 to the third part C3 respectively become gradually larger.

That is, a radius r2 of the second part C2 becomes larger as it goes away from the first part C1 in a counterclockwise direction in the cross section of FIG. 4. Further, a radius r3 of the third part C3 becomes larger at the same rate as the radius r2 of the second part C2 as it goes away from the first part C1 in a clockwise direction (r2=r3). The “egg shape” having its starting point at the lip 53 has an arch shape in which a radius of an arc part extending from the second part C2 to the first part C1 becomes smaller and a radius of an arc part extending from the first part C1 to the third part C3 becomes larger.

The lip 53 has a convex-shaped curved surface with a specified radius r4 which extends from the lower-end portion 531 (the first upper-end portion 511) to the third upper-end portion 532 (the second inner-end portion 521). The second cavity section 52 has a recess-shaped curved surface with a specified radius r5 which extends from the second bottom portion 522 to the rising wall area 525. The second upper-end portion 523 has a convex-shaped curved surface with a radius r6. When a distance, in the cylinder-axis direction A, between a central point of the radius r4 and a central point of the radius r5 is defined as a first distance Sv and a distance, in the radial direction B, between a central point of the radius r5 and a central point of the radius r6 is defined as a second distance Sh, respective numerical values of the radiuses r4, r5, and r6 are selected so as to meet the following expressions.

r4+r5>Sv

r5+r6≤Sh

In the second cavity section 52, a part extending from the second bottom portion 522 to an upper-end part C4 of the rising wall area 525 is formed by a nearly ¼ circle having the radius r5. The upper-end part C4 of the rising wall area 525 is continuous to a lower-end position of the second upper-end portion 523 which is formed by a nearly ¼ circle having the radius r6. Herein, an upper end of the second upper-end portion 523 is continuous to the squish area 55.

According to the above-described curved-surface shape, a lower part of the rising wall area 525 is positioned on the inward side, in the radial direction B, of the upper-end part C4 of the rising wall area 525. That is, the rising wall area 525 does not have any portion which is concaved outwardly in the radial direction B like the radial-direction concaved portion 514 of the first cavity section 51. The reason why the rising wall area 525 has the above-described arc shape is that the rising wall area 525 works with the above-described “egg shape” of the first cavity section 51 so that the air-fuel mixture can be prevented from excessively returning inwardly in the radial direction B in the combustion chamber 6 and a space (a squish space) above the squish area 55 positioned on the outward side, in the radial direction B, of the rising wall area 525 can be effectively utilized for appropriate combustion of the air-fuel mixture, which will be described later more specifically.

[Specific Structure of Injector]

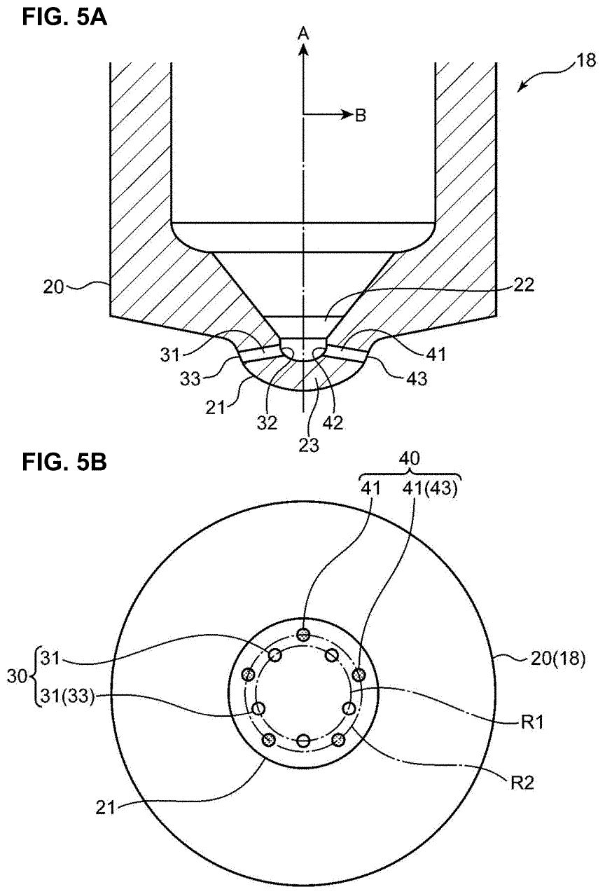

Subsequently, the structure of the injector 18 will be described. FIG. 5A is a schematic sectional view of a tip portion 20 of the injector 18, and FIG. 5B is a plan view of the tip portion 20, when viewed from a downward side in the cylinder-axis direction A. The injector 18 has the top portion 20 which is provided to protrude into the combustion chamber 6 from the combustion-chamber ceiling surface 6U for directly injecting the fuel into the combustion chamber 6. A nozzle head 21 which is provided with plural injection holes to inject the fuel into the combustion chamber 6 is disposed at a lower end of the tip portion 20. The nozzle head 21 is configured to protrude in a hemispherical shape from the lower end of the tip portion 20. A sack portion 22 which is a space where the fuel to be injected is filled is provided inside the tip portion 20. The sack portion 22 is a corn-shaped space and partitioned by a sack wall 23.

The present embodiment is characterized in that a first injection-hole group 30 and a second injection-hole group 40 are provided as the plural injection holes formed at the nozzle head 21, wherein respective fuel-injection directions of these groups 30, 40 are different from each other. The first injection-hole group 30 includes plural first injection holes 31 which are arranged in a ring shape along a first ring-shaped line R1. FIG. 5B shows an example in which the five first injection holes 31 are arranged in the ring shape along the first ring-shaped line R1 at regular intervals. Each of the first injection holes 31 is provided to penetrate the sack wall 23 and connect the sack portion 22 and the outside (the combustion chamber 6), which comprises an injection-hole inlet 32 which is opened to the sack portion 22 and an injection-hole outlet 33 which is opened to an outer surface of the nozzle head 21.

The second injection-hole group 40 includes plural first injection holes 41 which are arranged in the ring shape along a second ring-shaped line R2 which is positioned outside the first ring-shaped line R1. Herein, in illustration of FIG. 5B, the distance between the ring-shaped lines R1, R2 is enlarged just for easy understanding. This figure shows an example in which the five second injection holes 41 are arranged in the ring shape along the second ring-shaped line R2 at regular intervals. Each of the second injection holes 41 is also provided to penetrate the sack wall 23 and connect the sack portion 22 and the outside (the combustion chamber 6), which comprises an injection-hole inlet 42 which is opened to the sack portion 22 and an injection-hole outlet 43 which is opened to the outer surface of the nozzle head 21.

The first-and-second ring-shaped lines R1, R2 are perpendicular to the cylinder-axis direction A. The second ring-shaped line R2 is located at a higher level than the first ring-shaped line R1 at the hemispherical-shaped nozzle head 21 protruding downwardly, so that the second ring-shaped line R2 is positioned on the outward side, in the radial direction, of the first ring-shaped line R1 in FIG. 5B which is the plan view, when viewed from below. Thus, the five first injection holes 31 (the injection-hole outlets 33) arranged along the first ring-shaped line R1 are arranged in the ring shape at the same level in the cylinder-axis direction A. Further, the five second injection holes 41 (the injection-hole outlets 43) arranged along the second ring-shaped line R2 are arranged in the ring shape at the same level in the cylinder-axis direction A, which is offset downwardly from the level of the first injection holes 31.

The first injection holes 31 of the first injection-hole group 30 and the second injection holes 41 of the second injection-hole group 40 are respectively formed at the sack wall 23 such that those are directed in relatively different directions. The first injection holes 31 are directed relatively toward a part close to the piston 5 in the cylinder-axis direction A. Meanwhile, the second injection holes 41 are directed relatively toward a part close to the combustion-chamber ceiling surface 6U in the cylinder-axis direction A. Herein, a difference and an offset quantity in a directional angle (injection-hole angle) between these holes 31, 41 are considerably small, and the first injection-hole group 30 and the second injection-hole group 40 are positioned so as to inject the fuel toward the lip 53 of the cavity 5C concurrently. That is, the first injection holes 31 and the second injection holes 41 are positioned such that respective fuel sprays from both of these injection holes 31, 41 hit against the lip 53 when the fuel injection is executed by the injector 18 at a certain crank angle.

As described above, the five first injection holes 31 and the five second injection holes 41 are respectively arranged in the ring shape at regular intervals. Further, in the present embodiment, the first injection holes 31 and the second injection holes 41 are provided at the nozzle head 21 such that each outlet of the second injection holes 41 (the injection-hole outlet 43) is located at a middle position, in a peripheral direction, between adjacent two outlets of the first injection holes 31 (the injection-hole outlets 31). Consequently, while the arrangement lines R1, R2 of the first injection holes 31 and the second injection holes 41 are different, the first injection holes 31 and the second injection holes 41 (the injection-hole outlets 33 and the injection-hole outlets 43) are alternately arranged at the nozzle head 21 substantially at regular pitches in the peripheral direction. By this regular-pitch injection-hole arrangement and the above-described offset injection-hole arrangement in the cylinder-axis direction A, improper interference of the fuel spray from the first injection holes 31 with the fuel spray from the second injection holes 41 can be suppressed.

An injection-hole diameter of the first injection hole 31 and an injection-hole diameter of the second injection hole 41 are set at the same size. That is, the first injection hole 31 is a cylindrical hole having the same inner diameter over a range from the injection-hole inlet 32 to the injection-hole outlet 33. Likewise, the second injection hole 41 is a cylindrical hole having the same inner diameter over a range from the injection-hole inlet 42 to the injection-hole outlet 43. These first-and-second injection holes 31, 41 have the same inner diameter. These injection-hole outlets 32, 42 connect to the common sack portion 22. Accordingly, while the fuel filled in the sack portion 22 is injected through the both injection-hole outlets 33, 43, since the both injection holes 31, 41 have the same injection-hole diameter, it is prevented that the fuel injection from the first-and-second injection-hole groups 30, 40 is improperly biased.

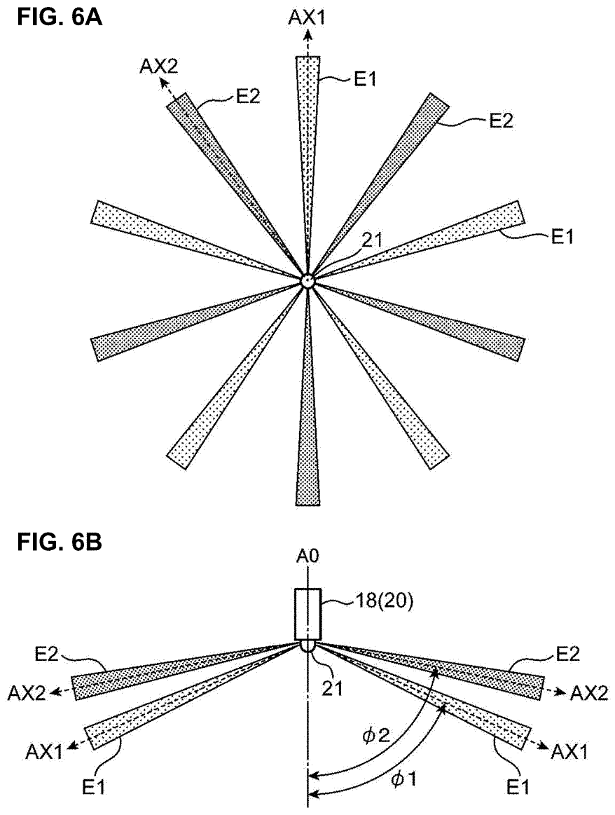

FIGS. 6A, 6B are schematic diagrams showing a state of the fuel spray from the injector 18, FIG. 6A being its diagram when viewed in the cylinder-axis direction A, FIG. 6B being its diagram when viewed in a direction perpendicular to the cylinder-axis direction A. In FIGS. 6A and 6B, a first fuel spray E1 which is injected from the first injection hole 31 of the first injection-hole group 30 and a second fuel spray E2 which is injected from the second injection hole 41 of the second injection-hole group 40 are shown. Further, injection-hole axes AX1, AX2 for the first-and-second fuel sprays E1, E2 are shown. The first-and-second fuel sprays E1, E2 spread in a corn shape with a specified spray angle around the respective injection-hole axes AX1, AX2. The first-and-second fuel sprays E1, E2 mix with air (oxygen) existing in the combustion chamber 6 and becomes the air-fuel mixture after being injected from the injection holes 31, 41.

As described above, the first injection holes 31 and the second injection holes 41 are alternately arranged at regular pitches in the peripheral direction. Accordingly, in FIG. 6A, the first fuel spray E1 and the second fuel spray E2 are aligned radially in the peripheral direction at regular intervals.

Meanwhile, in FIG. 6B, there occurs a difference of the fuel-injection direction which is caused by the difference of the directive direction between the first injection hole 31 and the second injection hole 41. In a relationship of the injection-hole axis AX1 of the first injection hole 31 and the injection-hole axis AX2 of the second injection hole 41, the injection-hole axis AX1 is directed relatively toward the part close to the piston 5, and the injection-hole axis AX2 is directed relatively toward the part close to the combustion-chamber ceiling surface 6U. In a case where the injector 18 is arranged along a cylinder axis A0, a first corn angle φ1 which is defined as an angle which the injection-hole axis AX1 makes with the cylinder axis A0 and a second corn angle φ2 which is defined as an angle which the injection-hole axis AX2 makes with the cylinder axis A0 have a relationship of φ1<φ2.

The first corn angle φ1 and the second corn angle φ2 are set by considering a positional relationship to the lip 53, the fuel-injection timing, the compression ratio, and others. For example, in a case where the fuel injection toward the lip 53 is conducted in an injection before a compression top dead center TDC (in a pre-injection P1, which will be described later), it is possibly set that the first corn angle φ1=76.0°, the second corn angle φ2=78.5°, and φ2−φ1=2.5°. The angle of φ2−φ1 is possibly set according to the size of the cylinder-axis direction A and the position, in the radial direction B, of the lip 53 and the like, but that is possibly selected from a range of φ2−φ1=1°-4°.

Herein, the “egg shape” of the cavity section shown in FIG. 4 is defined based on the single injection-hole axis AX. In the present embodiment, there exist the two injection-hole axes AX1, AX2 having the different corn angles. Regarding the above-described “egg shape”, any one of the injection-hole axes AX1, AX2 may be set as “AX” in FIG. 4, or an imaginary injection-hole axis having a middle corn angle of these axes AX1, AX2 may be set as “AX” in FIG. 4.

[Spatial Distribution of Fuel Spray]

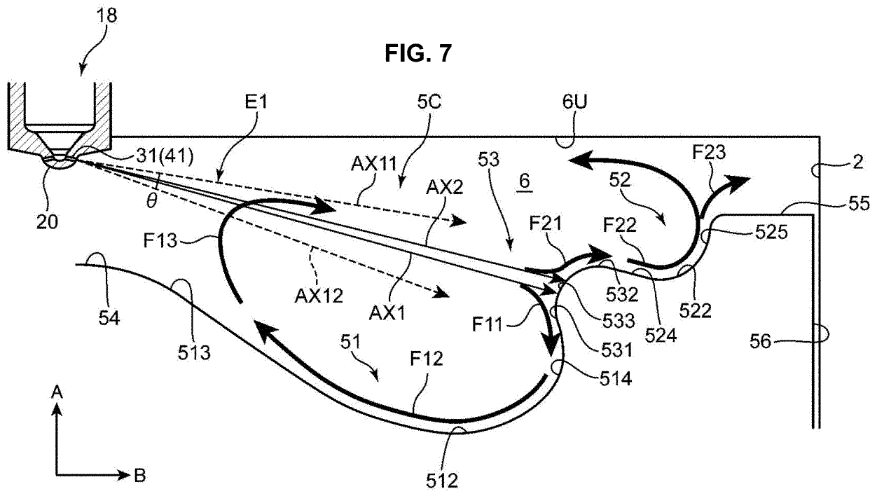

Next, a state of the fuel injection to the cavity 5C conducted by the injector 18 and a flow of the air-fuel mixture after the fuel injection will be described referring to FIG. 7. FIG. 7 is a sectional view of the combustion chamber 6, which schematically shows relationships between the crown surface 50 (the cavity 5C) and the injection-hole axes AX1, AX2 of the first-and-second fuel sprays E1, E2 injected from the injector 18 and arrows F11, F12, F13, F21, F22 and F23 which schematically represent the flow of the air-fuel mixture after the fuel injection.

FIG. 7 shows the state where the fuel is injected from the single first injection hole 31 among the plural injection holes provided at the injector 18 which belongs to the first injection-hole group 30. The fuel injected from the first injection hole 31 is sprayed along the injection-hole axis AX1 shown in this figure. The sprayed fuel spreads with a spray angle θ. In FIG. 7, an upper spreading axis AX11 which represents upward spreading relative to the injection-hole axis AX1 and a lower spreading axis AX12 which represents downward spreading relative to the injection-hole axis AX1 are shown. The spray angle θ is an angle which the upper spreading axis AX11 makes with the lower spreading axis AX12. That is, the first fuel spray E1 injected from the first injection hole 31 along the injection-hole angle AX1 goes toward the lip 53, spreading in the corn shape with the spray angle θ. The second fuel spray E2 injected from the second injection hole 41 along the injection-hole angle AX2 also goes toward the lip 53, spreading in the corn shape with the spray angle θ, which is not illustrated in FIG. 7.

Both of the injection-hole axis AX1 and the injection-hole axis AX2 are possibly directed toward the lip 53 of the cavity 5C concurrently. That is, the first injection hole 31 and the second injection hole 41 can inject the fuel toward the lip 53 at the same injection timing. Thus, by making the injector 18 execute the fuel injection at the certain crank angle of the piston 5, the fuel spray can be injected toward the lip 53 from both of the first injection hole 31 and the second injection hole 41 with the above-described corn angle difference φ2−φ1. In FIG. 7, the positional relationship at the above-described specified crank angle between the cavity 5C and the injection-hole axes AX1, AX2 is shown. The fuel injected from the first injection hole 31 and the second injection hole 41 (the first fuel spray E1 and the second fuel spray E2) forms the air-fuel mixture together with the air existing in the combustion chamber 6 and hits against the lip 53.

As shown in FIG. 7, the first fuel spray E1 and the second fuel spray E2 which are injected toward the lip 53 along the injection-hole axes AX1, AX2 hit against the lip 53, then are spatially divided into the one (the arrow F11) directed toward the first cavity section 51 (downwardly) and the other one (the arrow F21) directed toward the second cavity section 52 (upwardly). That is, the fuel injected toward the central portion 533 of the lip 53 is divided vertically, and then these vertically-divided fuel come to flow along the respective surfaces of the cavity sections 51, 52, forming the air-fuel mixture together with the air existing in the cavity sections 51, 52.

Specifically, the air-fuel mixture flowing in the direction of the arrow F11 (downwardly) goes down into the radial-direction concaved portion 514 of the first cavity section 51 from the lower end portion 531 of the lip 53 and flows in the downward direction. Then, this air-fuel mixture changes its flowing direction from the vertical direction to the inward direction in the radial direction B because of the curved-surface shape of the radial-direction concaved portion 514, and then flows along the bottom surface of the first cavity section 51 having the first bottom portion 512 as shown by the arrow F12. In this case, the air-fuel mixture further mixes with the air of the first cavity section 51, thereby diluting its concentration. The bottom surface of the first cavity section 51 is configured to protrude upwardly toward a center, in the radial direction, of the bottom surface of the first cavity section 51 due to existence of the mountain section 54. Accordingly, the air-fuel mixture flowing in the arrow F12 direction is raised upward, and finally flows toward the outward side, in the radial direction, from the combustion-chamber ceiling surface 6U as shown by the arrow F13. In this case, the air-fuel mixture further mixes with the air remaining in the combustion chamber 6 of the first cavity section 51, thereby diluting its concentration so as to become the homogeneous and thin mixture.

Meanwhile, the air-fuel mixture flowing in the direction of the arrow F12 (upwardly) goes down into the taper area 524 of the second cavity section 52 from the upper end portion 532 of the lip 53 and flows obliquely downwardly along an inclination of the taper area 524. Then, this air-fuel mixture reaches the second bottom portion 522 as shown by the arrow F22. Herein, the taper area 524 is a surface having the inclination along the injection-hole axes AX1, AX2. Therefore, the air-fuel mixture can smoothly flow outwardly in the radial direction. That is, the air-fuel mixture can reach an outwardly-deep position of the combustion chamber 6 because of respective existences of the taper area 524 and the second bottom portion 522 positioned at the lower level than the third upper-end portion 532 of the lip 53.

After this, the above-described air-fuel mixture is raised upwardly from a rising curved surface positioned between the second bottom portion 522 and the rising wall area 525, and then flows toward the inward side in the radial direction from the combustion-chamber ceiling surface 6U. In the process of the flow shown by the arrow F22, the air-fuel mixture further mixes with the air existing in the second cavity section 52 and becomes the homogeneous and lean mixture. Herein, since the rising wall area 525 extending nearly in the vertical direction exists on the outward side, in the radial direction, of the secant bottom portion 522, it is prevented that the injected fuel (the air-fuel mixture) reaches the inner wall surface of the cylinder 2 (in general, a cylinder liner, not illustrated, exists). That is, the above-described air-fuel mixture is possibly made to flow up to a position near the outward side, in the radial direction, of the combustion chamber 6 by the second bottom portion 522, but it can be suppressed by the rising wall area 525 that this mixture interferes with the inner peripheral wall of the cylinder 2. Thereby, any improper cooling loss caused by the above-described interference can be properly suppressed.

Herein, the lower part of the rising wall area 525 is configured to be positioned on the inward side, in the radial direction B, of the upper end of the rising wall area 525. Accordingly, the flow shown by the arrow F22 does not become excessively strong, so that the air-fuel mixture can be prevented from flowing back inwardly in the radial direction B too much. If the flow shown by the arrow F22 was too strong, the air-fuel mixture burning partially might hit against the fuel newly injected before this newly-injected fuel spreads sufficiently, so that homogeneous burning (combustion) of the air-fuel mixture might be so hindered that some soot and the like might be generated improperly. However, since the rising wall area 525 of the present embodiment does not have any outwardly-hollowed shape, the flow of the arrow F22 is so repressive that a flow going outwardly in the radial direction B which is shown by the arrow F23 is generated as well. Especially, it is likely that the flow shown by the arrow F23 is generated because it is pulled by a reverse squish flow in a later stage of burning of the air-fuel mixture as well. Accordingly, the appropriate burning of the air-fuel mixture can be attained by effectively utilizing a space located on the outward side, in the radial direction, of the rising wall area 525 (i.e., a space on the squish area 55). Thereby, generation of the soot and the like is so suppressed that the burning (combustion) utilizing a whole part of the space in the combustion chamber can be attained.

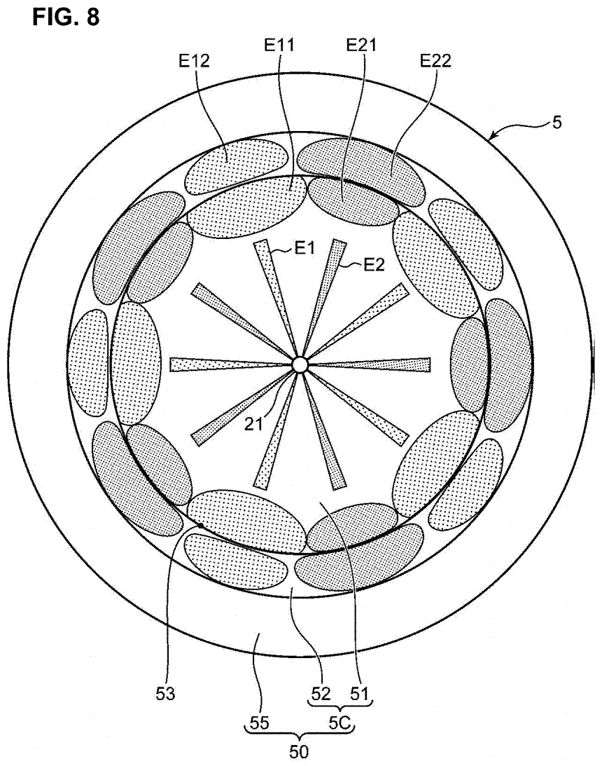

FIG. 8 is a top view of the piston 5, which schematically shows a distribution pattern of the fuel spray to the first-and-second cavity sections 51, 52. The first fuel spray E1 injected toward the lip 53 along the injection-hole axis AX1 is divided into a lower-stage spray E11 and an upper-stage spray E12 by the above-described spatial distribution performance as shown in FIG. 8. Likewise, the second fuel spray E2 injected toward the lip 53 along the injection-hole axis AX2 is divided into a lower-stage spray E21 and an upper-stage spray E22. Thereby, the air-fuel mixture can be generated by effectively utilizing the oxygen existing in the respective spaces of the first-and-second cavity sections 51, 52. That is, the homogeneous and lean air-fuel mixture can be generated by widely using the space of the combustion chamber 6, so that the generation of the soot and the like during the fuel combustion can be properly suppressed.

[Temporal Distribution of Fuel Injection]

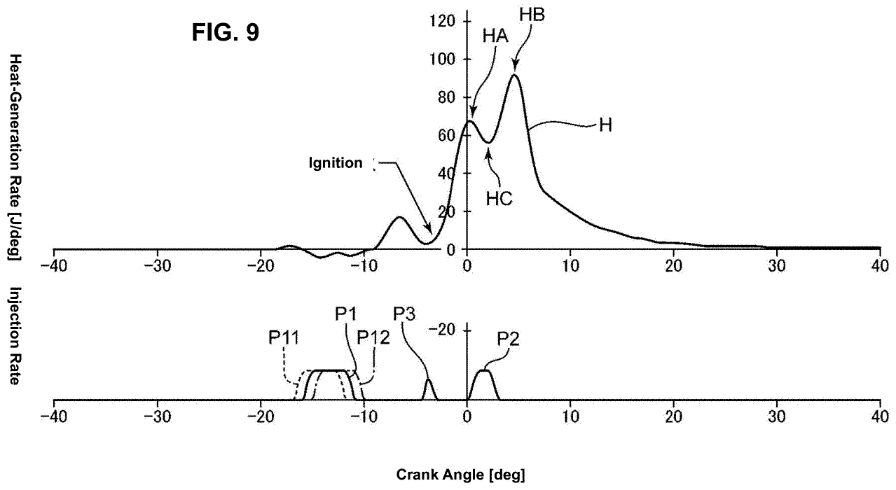

The present embodiment shows an example where the fuel spray is distributed temporally in addition to the above-described spatial distribution, thereby more effectively utilizing the air existing in the combustion chamber 6. FIG. 9 shows an example of the timing of the fuel injection from the injector 18 to the cavity 5C and a time chart showing a heat-generation-rate characteristic H. The fuel injection executed by the injector 18 is controlled by a fuel-injection controller 18A (see FIG. 1). The fuel-injection controller 18A makes the injector 18 execute the pre-injection P1, a main-injection P2, and a middle-stage injection P3.

The pre-injection P1 is the fuel injection which is executed when the piston 5 is positioned on an advanced side of the compression top dead center (TDC). The pre-injection P1 aims at premixed combustion of the injected fuel, which is executed in a later stage of a compression stroke where a cylinder-inside pressure and a cylinder-inside temperature become considerably high respectively. The main-injection P2 is executed on a delayed side of the pre-injection P1 and started during a period of the premixed combustion of the fuel injected by the pre-injection P1. That is, the main-injection P2 aims at diffusion combustion of the injected fuel by utilizing the heat of the premixed combustion, which is started when the piston 5 is positioned nearly at TDC. The middle-stage injection P3 is the fuel injection which is executed between the pre-injection P1 and the main-injection P2. It is intended that the fuel injected by the middle-stage injection P3 is burned during a period between the combustion of the pre-injection P1 and the combustion of the main-injection P2. The middle-stage injection P3 is substantially the diffusion combustion as well.

FIG. 9 shows an example where the pre-injection P1 is executed during of a period from the crank angle—CA 16 degrees to the crank angle—CA 12 degrees. The pre-injection P1 and the main-injection P2 have the same peak value of a fuel injection rate, but it is set that the pre-injection P1 has a longer fuel injection period than the main-injection P2. Further, FIG. 9 shows an example where the middle-stage injection P3 is started at the crank angle—CA 6 degrees. The middle-stage injection P3 injects a smaller amount of fuel than the pre-injection P1 and the main-injection P2.

The heat-generation-rate characteristic H of the respective combustions of the pre-injection P1, the main-injection P2, and the middle-stage injection P3 is shown in FIG. 9. The heat-generation-rate characteristic H is a characteristic deeply related to an increase rate of a combustion pressure in the combustion chamber 6, which comprises a front-stage combustion part HA which corresponds to a peak generated by the premixed combustion of the pre-injection P1, a later-stage combustion part HB which corresponds to a peak generated by the diffusion combustion of the main-injection P2, and a middle-stage combustion part HC which is located between the both combustion parts HA, HB. That is, the heat-generation-rate characteristic H has two-stage peaks of the heat generation which are caused by the pre-injection P1 and the main-injection P2 which are executed separately in time and inject a relatively large amount of fuel. The middle-stage injection P3 is the fuel injection to suppress the heat-generation-rate peaks of the respective combustions of the pre-injection P1 and the main-injection P2. The middle-stage injection P3 contributes to reduction of combustion noise by this peak suppression.

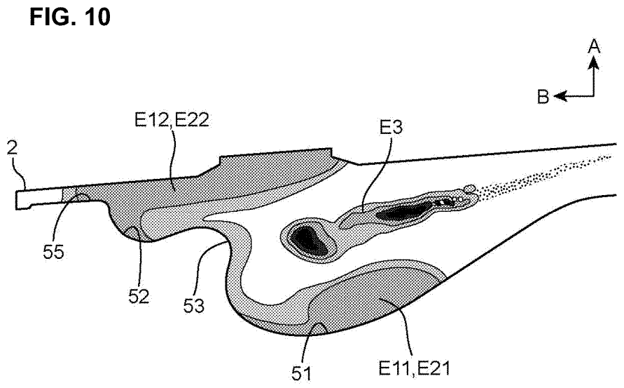

The above-described fuel spraying directed toward the lip 53 is executed in the pre-injection P1. The main-injection P2 injects the fuel to a middle position between the vertically separated air-fuel mixtures which has been formed in the lower-side first cavity section 51 and the upper-side second cavity section 52 by the fuel injection of the pre-injection P1 as described above (see the lower-stage sprays E11, E21 and the upper-stage sprays E12, E22 in FIG. 8). This point will be described referring to FIG. 10. FIG. 10 is a diagram schematically showing a generation state of the air-fuel mixtures in the combustion chamber 6 at the timing when the main-injection P2 is terminated.

The first fuel spray E1 of the pre-injection P1 becomes the air-fuel mixture through its mixing with the air existing in the combustion chamber 6 and then hits against the lip 53. By this hitting against the lip 53, the first-and-second fuel sprays E1, E2 are respectively divided into the lower-stage sprays E11, E21 going to the first cavity section 51 and the upper-stage sprays E12, E22 going to the second cavity section 52 as shown in FIG. 10. These are the above-described vertically-separated distribution of the air-fuel mixtures. The main-injection P2 is the fuel injection to be executed in order to form a new air-fuel mixture by utilizing air which remains in a space positioned between the two separately-formed air-fuel mixtures which have been previously formed in the first-and-second cavity sections 51, 52 by the pre-injection P1.

Further description will be added referring to FIG. 10. Since the piston 5 is positioned substantially at the TDC at the execution timing of the main-injection P2, the fuel of the main-injection P2 is injected toward a position located at a slightly lower level than the lip 53. The lower-stage sprays E11, E21 and the upper-stage sprays E12, E22 which have been previously injected by the pre-injection P1 flow into the first-and-second cavity sections 51, 52 and mix with the air existing in the respective spaces, respectively, so that dilution advances. There exists unused air (air having not been mixed with the fuel yet) between the lower-stage sprays E11, E21 and the upper-stage sprays E12, E22 at a timing right before starting of the main-injection P2. Herein, the “egg shape” of the first cavity section 51 contributes to forming of a layer of this unused air. The fuel injected by the main-injection P2 goes into a space between the lower-stage sprays E11, E21 and the upper-stage sprays E12, E22, and mixes with the above-described unused air, thereby becoming a main-fuel spray E3. This is a temporal distribution of the fuel spray. As described above, in the present embodiment, the combustion effectively utilizing the air existing in the combustion chamber 6 can be attained by the spatial-and-temporal distributions of the fuel injection.

[Merit of Multi-Corn Angles]

The injector 18 of the present embodiment includes the first injection-hole group 30 having the plural first injection holes 31 relatively directed to the part close to the piston 5 and the second injection-hole group 40 having the plural first injection holes 41 relatively directed to the part close to the combustion-chamber ceiling surface 6U. That is, this injector 18 is a so-called multi-corn angle type provided with the injection holes having the different corn angles. A merit of this multi-corn angle type of injection will be described.

There is a case where the injection timing (execution timing) of the pre-injection P1 shown in FIG. 9 is needed to be advanced or delayed according to a driving condition or the like in order to secure the appropriate combustion. For example, a wall-surface temperature, the cylinder-inside pressure, and the cylinder-inside temperature of the cylinder 2 change depending on an outside temperature, an outside pressure, an engine-coolant temperature, etc. The execution timing of the pre-injection P1 needs to be adjusted in order to maintain the desired heat-generation-rate characteristic H (the peak occurrence timing of the front-stage/later-stage combustion parts HA, HB) regardless of a change of the above-described environmental factors. Specifically, as shown in a lower part in FIG. 9, there is a case where the start timing of the pre-injection P1 is changed to a pre-injection P11 which is advanced from a normal timing or to a pre-injection P12 which is delayed from the normal timing.

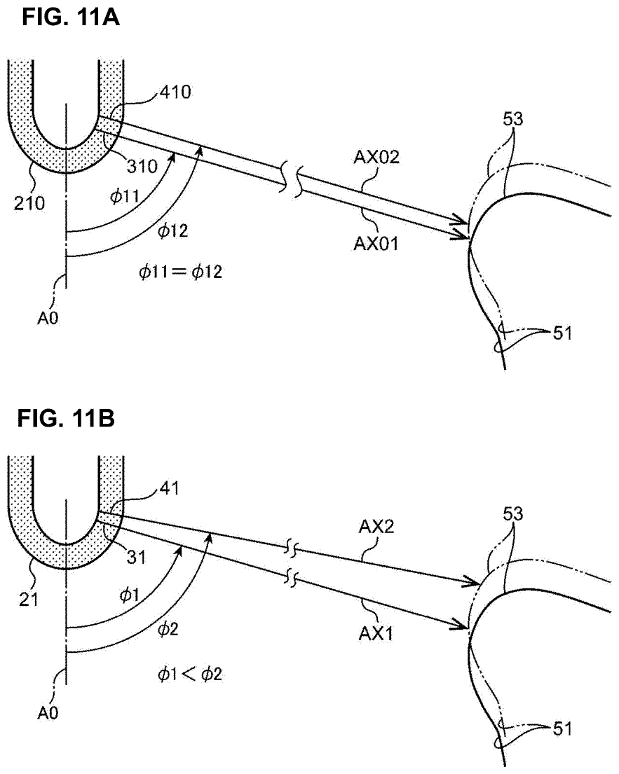

FIGS. 11A, 11B are diagrams showing injection states of the fuel injected toward the lip 53, FIG. 11A showing a case of a comparative example using a nozzle head 210, FIG. 11B showing a case of the present embodiment using the nozzle head 21. The nozzle head 210 of the comparative example is provided with a first injection hole 310 and a second injection hole 410 which are offset from each other in the cylinder axis A0 similarly to the present embodiment. However, an injection-hole axis AX01 of the first injection hole 310 and an injection-hole axis AX02 of the second injection hole 410 are parallel to each other. That is, a first corn angle φ11 of the injection-hole axis AX01 and a second corn angle φ12 of the injection-hole axis AX02 relative to the cylinder axis A0 are equal to each other (φ11=12).

In FIG. 11A, the lip 53 shown by a solid line shows a level (height) position of the lip 53 at the execution timing of the pre-injection P1 shown in FIG. 9. In this case, since both of the injection-hole axes AX01, AX02 are directed toward the lip 53, the above-described spatial distribution of the fuel spray can be appropriately achieved. Meanwhile, the lip 53 shown by a dotted line shows a level (height) position of the lip 53 at the execution timing of the delayed pre-injection P12. In this case, both of the injection-hole axes AX01, AX02 are directed toward the vicinity of a lower end of the lip 53 or the vicinity of an upper end of the first cavity section 51. Accordingly, the fuel spray shows its biased distribution such that there exists a large amount of fuel spray in the first cavity 51 but there exists a small amount of fuel spray in the second cavity section 52. That is, the above-described appropriate fuel-spray spatial distribution is not able to be maintained. In this case, there may occur a problem that the oxygen is not utilized sufficiently in the second cavity section 52, whereas the fuel is not burned perfectly in the first cavity section 51.

On the contrary, in the case of using the nozzle head 21 of the present embodiment, the appropriate spatial distribution of the fuel spray can be maintained regardless of the delayed pre-injection P1 (or the advanced pre-injection P1). That is, the nozzle head 21 is configured such that the first corn angle φ1 of the injection-hole axis AX1 of the first injection hole 31 and the second corn angle φ2 of the injection-hole axis AX2 of the second injection hole 41 are different from each other (φ11≤φ12). Accordingly, the larger (stronger) the penetration becomes, the wider the distance between the injection-hole axis AX1 and the injection-hole axis AX2 becomes. Thereby, the injection-hole angle of the injector 18 can be properly enlarged.

Accordingly, the fuel spray directed toward the lip 53 can be attained at the level position (shown by the solid line) of the lip 53 at the execution timing of the pre-injection P1, and also the fuel spray directed toward the lip 53 can be attained at the level position (shown by the dotted line) of the lip 53 at the execution timing of the delayed pre-injection P1. Thus, the fuel spray can be distributed properly to the first-and-second cavity sections 51, 52, not being biased, even in the case where the pre-injection P1 is delayed or advanced.

Herein, the injection-hole angle may be possibly enlarged by enlarging the outlet diameter of the injection hole in place of adopting the multi-corn angles of the injection hole. However, it is necessary to enlarge a volume of the sack portion 22 for the purpose of securing the sufficient penetration, enlarging the injection-hole angle, and this may not be preferable because the large-sized injector is required. Moreover, the enlarged outlet diameter of the injection hole may cause a unpreferable concern that the fuel remaining inside the sack portion 22 drips and thereby a fuel deposit is improperly generated.

[Merit of Offset Arrangement of Injection Holes]

As shown in FIG. 5B, in the nozzle head 21 of the present embodiment, the first injection holes 31 (the injection-hole outlets 33) and the second injection holes 41 (the injection-hole outlets 43) are offset in the cylinder-axis direction A, and each one of the second injection holes 41 is arranged so as to be located at the central position, in the peripheral direction, of the adjacent two holes of the first injection holes 31 (hereafter, this injection-hole arrangement will be referred to as a zigzag arrangement). This injection-hole arrangement can suppress any improper mutual interference of the fuel spray, so that the fuel spray can be distributed into the space of the combustion chamber 6 more homogeneously.

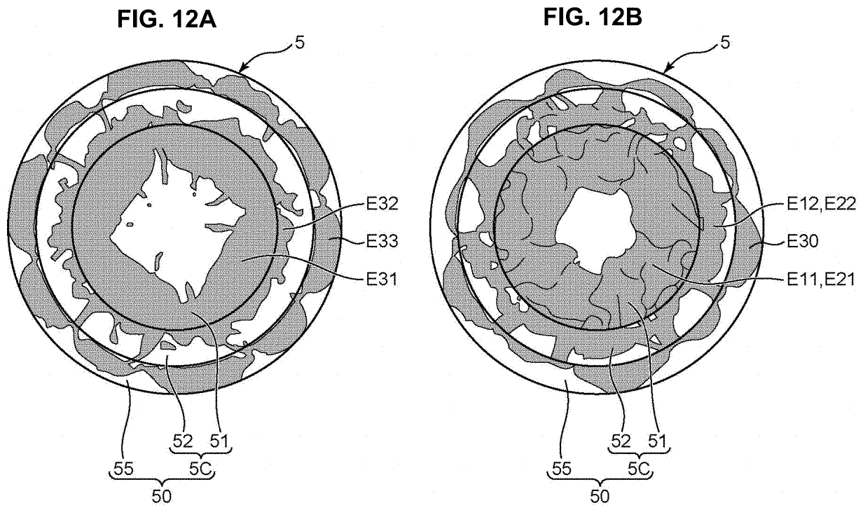

FIGS. 12A, 12B are diagrams showing distribution states of the fuel spay, FIG. 12A showing a case of the comparative example, FIG. 12B showing a case of the present embodiment. FIG. 12A shows the fuel-spray distribution state of the comparative example using a nozzle head which is configured such that ten injection holes are arranged in a line on a single ring-shaped line and these injection holes have the same injection-hole angle. It is found in the comparative example that a large amount of fuel spray E31 flows into the first cavity section 51, whereas a small amount of fuel spray E32 flows into the second cavity section 52. Further, it is found that the fuel spray E31 does not flow into a central area in the first cavity section 51. Accordingly, it appears that the oxygen in the combustion chamber is not effectively utilized. Moreover, it is found that a fuel spray E33 flows deeply into the squish area 55 and contacts the inner wall surface of the cylinder 2. This may cause improper cooling loss.

This problem is primarily caused by the arrangement that the injection holes are arranged on the single ring-shaped line as well. In the case where the injection holes are provided at the nozzle head so as to be arranged in a line in the ring shape, the distance between the adjacent injection-hole outlets in the peripheral direction is so small that the injection sprays injected from the adjacent injection-hole outlets interfere with each other. Accordingly, the flowing of the fuel sprays is so hindered that it becomes difficult for the fuel sprays E31, E32 to flow deeply into the first-and-second cavity sections 51, 52. Also, an rich air-fuel mixture is possibly generated at a part where the fuel sprays interfere with each other improperly.

On the contrary, it is found in the present embodiment shown in FIG. 12B that the lower-stage injection sprays E11, E21 are properly distributed in the first cavity section 51 and the upper-stage injection sprays E12, E22 are properly distributed in the second cavity section 52. Further, it is found that the lower-stage injection sprays E11, E21 flow deeply into the first cavity section 51 up to its central area in the radial direction and the upper-stage injection sprays E12, E22 flow deeply into the second cavity section 52 up to its outside in the radial direction. It is also found that the fuel spray E3 does not flow deeply into the squish area 55.

These are caused by the first injection holes 31 and the second injection holes 41 of the present embodiment, which are arranged at regular intervals and adopt the above-described zigzag arrangement and the respective injection-hole axes AX1, AX2 of which have the different corn angles φ1, φ2. Thereby, it is unlikely that the fuel sprays injected from the first-and-second injection holes 31, 41 interfere with each other, and the above-described fuel-sprays' deeply-flowing into the cavity sections is achieved.

[Examples of Various Kinds of Injection-Hole Arrangement]

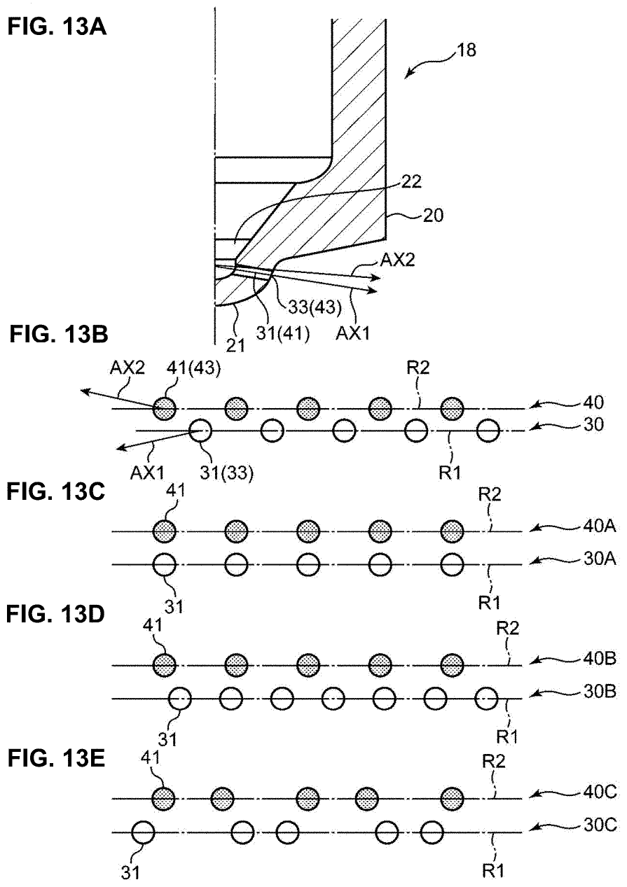

Subsequently, examples of various kinds of injection-hole arrangement of the first-and-second injection holes 31, 41 having the different hole-directions which are provided at the nozzle head 21 will be described. In a case where the first injection holes 31 (the injection-hole outlets 33) and the second injection holes 41 (the injection-hole outlets 43) are offset from each other as shown in FIG. 13A, injection-hole arrangement patterns shown in FIGS. 13B-13E can be exemplified. FIGS. 13B-13E show linearly-exploded pattern diagrams of the first injection holes 31 and the second injection holes 41 which are actually arranged in the ring shape along the ring-shaped lines R1, R2.

FIG. 13B is the pattern corresponding to the zigzag arrangement shown in FIG. 5B. The first injection holes 31 are arranged on the ring-shaped line R1 at regular intervals and the second injection holes 41 are arranged on the ring-shaped line R2 which is offset from the ring-shaped line R1 at regular intervals, which respectively form the first injection-hole group 30 and the second injection-hole group 40. The second injection holes 41 are located at a half-pitch offset position relative to the first injection holes 31. As described above, since the zigzag arrangement is adopted, improper interference between the respective fuel sprays injected from the first-and-second injection holes 31, 41 can be suppressed, in addition to a cause of the difference of the injection-hole axes AX1, AX2 of the first-and-second injection holes 31, 41, so that the fuel sprays can be distributed so as to flow into the first-and-second cavity sections 51, 52.

The injection-hole arrangement pattern shown in FIG. 13C shows the example in which the first injection holes 31 and the second injection holes 41 are arranged at same position in the peripheral direction. That is, the first injection holes 31 of a first injection-hole group 30A and the second injection holes 41 of a second injection-hole group 40A are arranged in the ring shape along the respective ring-shaped lines R1, R2 without being offset from each other in the peripheral direction. According to this arrangement pattern, it is likely that interference, in the peripheral direction, of the fuel sprays injected from the respective adjacent injection holes of the first-and-second injection holes 31, 41 can be suppressed more. Further, this suppression of the interference of the radial-direction fuel sprays may make a size of an arrangement part of the injection holes small, so that the injector 18 can be properly small sized.

The injection-hole arrangement pattern shown in FIG. 13D shows the example in which the number of the first injection holes 31 and the number of the second injection holes 41 are differentiated. A first injection-hole group 30B is configured such that the seven first injection holes 31 are arranged along the ring-shaped line R1 at regular intervals, whereas a second injection-hole group 40B is configured such that the five second injection holes 41 are arranged along the ring-shaped line R2 at regular intervals. It is apparent that the arrangement pitch of the first injection holes 31 is relatively narrow. This injection-hole arrangement pattern can be used in a case where the amount of fuel injection injected toward the piston 5 (the first cavity section 51) is needed to be relatively increased, for example.

The injection-hole arrangement pattern shown in FIG. 13E shows the example in which the first injection holes 31 and the second injection holes 41 are arranged at irregular pitches in the peripheral direction. The first injection holes 31 of a first injection-hole group 30C and the second injection holes 41 of a second injection-hole group 40C are arranged in the ring shape at irregular pitches along the respective ring-shaped lines R1, R2. This injection-hole arrangement pattern can suppress the interference of the fuel sprays as well.

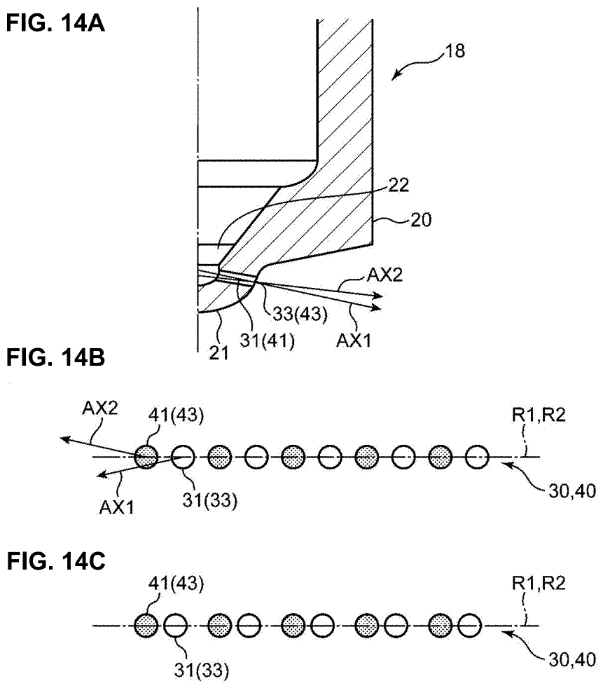

Further, it is possible that the first injection holes 31 (the injection-hole outlets 33) and the second injection holes 41 (the injection-hole outlets 43) are arranged so as not to be offset from each other as shown in FIG. 14A. In this arrangement, the first injection holes 31 and the second injection holes 41 are aligned in a line in the peripheral direction at the nozzle head 21. In this case, the injection-hole arrangement pattern shown in FIGS. 14B, 14C can be exemplified.

In the injection-hole arrangement pattern shown in FIG. 14B, the first-and-second injection holes 31, 41 are respectively arranged in the ring shape along the ring-shaped lines R1, R2 which are set at the same level (height position). The five first injection holes 31 are arranged at regular intervals. The five second injection holes 41 are located at the half-pitch offset position relative to the first injection holes 31. Consequently, the ten first-and-second injection holes 31, 41 which are aligned alternately are arranged at regular intervals along the ring-shaped lines R1, R2 which are located at the same level. Even in this arrangement pattern, since the injection-hole axis AX1 of the first injection holes 31 has the different direction from the injection-hole axis AX2 of the first injection holes 41, the appropriate distribution of the fuel spray to the first-and-second cavity sections 51, 52 can be achieved.

The injection-hole arrangement pattern shown in FIG. 14C shows the example in which the first injection holes 31 and the second injection holes 41 are arranged in the ring shape at irregular pitches along the ring-shaped lines R1, R2 located at the same level. While the five first injection holes 31 and the five second injection holes 41 are arranged alternately along the lines R1, R2 located at the same level, its arrangement pitches are irregular. Herein, the injection-hole arrangement pattern shown in FIG. 14C can be also recognized that a pair of the first injection hole 31 and the second injection hole 41 are arranged at regular intervals along the ring-shaped lines R1, R2.

[Operational Effect]

According to the compression ignition engine of the present embodiment described above, the first injection-hole group 30 having the plural first injection holes 31 directed toward the part close to the piston 5 and arranged in the ring shape and the second injection-hole group 40 having the plural second injection holes 41 directed toward the part close to the combustion-chamber ceiling surface 6U and arranged in the ring shape are provided as the plural injection holes of the injector 18. These first-and-second injection-hole groups 30, 40 inject the fuel toward the lip 53 concurrently. Thereby, an injection-hole angle of the injector 18 can be enlarged. Accordingly, even in a case where the fuel injection timing of the pre-injection P1 is advanced or delayed to a certain degree, the fuel splay is made to hit against the lip 53 so that the fuel spay can be separately flowed into the first cavity section 51 and the second cavity section 52 properly. Accordingly, the flowing of the fuel spray is prevented from deflecting to either one of the cavity sections, so that the oxygen existing in the combustion chamber 6 can be utilized effectively and also appropriate burning of the fuel can be attained, suppressing generation of any improper soot.

What is claimed is:

1. A compression ignition engine, comprising:
a combustion chamber formed by a cylinder, a ceiling surface of a cylinder head, and a crown surface of a piston;
a fuel injector provided at a central portion, in a radial direction, of the ceiling surface of the cylinder along a cylinder axis and including plural injection holes to inject fuel into the combustion chamber; and
a cavity provided at the crown surface of the piston,
wherein said cavity includes a first cavity section which is provided in a central area, in the radial direction, of said crown surface and has a first bottom portion having a first depth, in a direction of the cylinder axis, from the crown surface, a second cavity section which is provided outside said first cavity section and has a second bottom portion having a second depth, in the direction of the cylinder axis, from the crown surface, said second depth being shallower than said first depth, and a lip which is provided to connect said first cavity section and said second cavity section,
said plural injection holes of the fuel injector include a first injection-hole group where plural first injection holes which are directed toward a part close to said piston in the cylinder-axis direction are provided in a ring shape and a second injection-hole group where plural second injection holes which are directed toward a part close to said ceiling surface in the cylinder-axis direction are provided in the ring shape, and
said first injection-hole group and said second injection-hole group are positioned so as to inject the fuel toward said lip concurrently.

2. The compression ignition engine of claim 1, wherein respective outlets of said plural first injection holes are provided in the ring shape at the same level in the cylinder-axis direction, and respective outlets of said plural second injection holes are provided in the ring shape at the same level in the cylinder-axis direction, said level at which the respective outlets of the plural second injection holes are provided being offset, in the cylinder-axis direction, from said level at which the respective outlets of the plural first injection holes are provided.

3. The compression ignition engine of claim 2, wherein said respective outlets of the plural first injection holes are provided in the ring shape at regular intervals, said respective outlets of the plural second injection holes are provided in the ring shape at regular intervals, and the outlets of the plural injection holes of said first-and-second injection-hole groups are arranged such that each outlet of the plural injection holes of one of said first-and-second injection-hole groups is located at a middle position between adjacent outlets of the plural injection holes of the other group.

4. The compression ignition engine of claim 1, wherein said fuel injector comprises a sack portion where the fuel is filled and a sack wall which partitions said sack portion which are provided at a tip portion thereof exposed to said combustion chamber, and said first injection holes of the first injection group and said second injection holes of the second injection group are respectively formed at said sack wall and have the same injection-hole diameter.
